(19) United States
(12) Patent Application Publication
(10) Pub. No.: US 2026/0111448 A1
(43) Pub. Date: Apr. 23, 2026

(54) METHOD OF DATA READING FOR STORAGE APPARATUS AND STORAGE APPARATUS

(71) Applicant: SAMSUNG ELECTRONICS CO., LTD., Suwon-si (KR)

(72) Inventors: Yafei WANG, Xi'an (CN); Kun DOU, Xi'an (CN)

(73) Assignee: SAMSUNG ELECTRONICS CO., LTD., Suwon-si (KR)

(21) Appl. No.: 18/944,451

(22) Filed: Nov. 12, 2024

(30) Foreign Application Priority Data
Oct. 17, 2024 (CN) 202411455191.0

(51) Int. Cl. G06F 16/28; G06F 16/2455; G06F 16/248

(52) U.S. Cl. CPC G06F 16/282; G06F 16/24558; G06F 16/248

(57) ABSTRACT

A method of data reading for a storage device, including: receiving, by the storage device, a search request from a host, wherein the search request includes an address of a file to be searched; loading the file into a computing unit included in the storage device based on the address; obtaining a search result by searching, by the storage device, for data to be read in the file; and returning the search result to the host.

### CROSS-REFERENCE TO RELATED APPLICATION(S)

This application is based on and claims priority under 35 U.S.C. § 119 to Chinese Patent Application No. 202411455191.0, filed on Oct. 17, 2024, in the China National Intellectual Property Administration, the disclosure of which is incorporated by reference herein in its entirety.

### BACKGROUND

### 1. Field

The disclosure relates to a field of storage technique, and more particularly, to a method of data reading for a storage apparatus and the storage apparatus.

### 2. Description of Related Art

A log structured merge tree (LSM-Tree) may be a hierarchical sorted data storage structure designed for the characteristics of a block storage apparatus. During a read operation on an LSM-Tree based database, if data to be read is not found in a memory table (Mem Table) or an immutable memory table (Immutable Mem Table), a sorted string table (SST) file, which may be stored in a hierarchical form inside a disk of the block storage apparatus, may be loaded into a host memory for the search. This search may not only reduce the efficiency of the read operation due to the large read amplification, but may also increase a central processing unit (CPU) occupancy rate and power consumption of a host.

### SUMMARY

Provided is a method of data reading for a storage apparatus and the storage apparatus to address part or all of the problems above.

Additional aspects will be set forth in part in the description which follows and, in part, will be apparent from the description, or may be learned by practice of the presented embodiments.

In accordance with an aspect of the disclosure, a method of data reading for a storage device includes: receiving, by the storage device, a search request from a host, wherein the search request includes an address of a file to be searched; loading the file into a computing unit included in the storage device based on the address; obtaining a search result by searching, by the storage device, for data to be read in the file; and returning the search result to the host.

In accordance with an aspect of the disclosure, a storage apparatus includes: at least one processor configured to implement a computing unit, wherein the computing unit is configured to: obtain a search request received by the storage apparatus from a host, wherein the search request includes an address of a file to be searched, load the file into the computing unit based on the address, obtain a search result by searching for data to be read in the file, and return the search result to the host.

In accordance with an aspect of the disclosure, a storage system, includes: a main processor;

a memory; and a storage apparatus, wherein the storage apparatus is configured to: receive a search request from a host, wherein the search request includes an address of a file to be searched, load the file into a computing unit included in the storage apparatus based on the address; obtain a search result by searching for data to be read in the file; and return the search result to the host.

In accordance with an aspect of the disclosure, a host storage system includes: a host; and a storage apparatus, wherein the storage apparatus is configured to: receive a search request from the host, wherein the search request includes an address of a file to be searched, load the file into a computing unit included in the storage apparatus based on the address; obtain a search result by searching for data to be read in the file; and return the search result to the host.

In accordance with an aspect of the disclosure, a data center system includes: a plurality of application servers; and a plurality of storage servers, wherein each storage server includes a storage apparatus, and wherein the storage apparatus is configured to: receive a search request from a host, wherein the search request includes an address of a file to be searched, load the file into a computing unit included in the storage apparatus based on the address; obtain a search result by searching for data to be read in the file; and return the search result to the host.

In accordance with an aspect of the disclosure, a computer-readable storage medium has a computer program instructions stored thereon, wherein the computer program instructions, when executed by at least one processor of a storage device, causes the storage device to: receive a search request from a host, wherein the search request includes an address of a file to be searched; load the file into a computing unit included in the storage device based on the address; obtain a search result by searching for data to be read in the file; and return the search result to the host.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a read process for RocksDB, according to an embodiment of the disclosure;

FIG. 2 illustrates a comparison block diagram between a computational storage drive (CSD) and a solid state drive (SSD) according to an embodiment;

FIG. 3 illustrates an interaction diagram of a host with a storage apparatus regarding a read operation according to an embodiment;

FIG. 4 illustrates flowcharts comparing a read operations according to an embodiment;

FIG. 5 illustrates a flowchart of a method of data reading for a storage apparatus according to an embodiment;

FIG. 6 illustrates a detailed flowchart of data reading according to an embodiment;

FIG. 7 illustrates a data flow comparison diagram according to an embodiment;

FIG. 8 illustrates a block diagram of an internal module of a storage apparatus according to an embodiment;

FIG. 9 is a diagram of a system to which a storage device is applied according to an embodiment.

FIG. 10 is a block diagram of a host storage system according to an embodiment.

FIG. 11 is a diagram of a data center to which a memory device is applied according to an embodiment.

### DETAILED DESCRIPTION

In order to enable a person of ordinary skill in the art to better understand the technical solutions of the disclosure, embodiments of the disclosure are described below in conjunction with the accompanying drawings.

It should be noted that the terms “first”, “second”, etc. are used herein to distinguish similar objects or elements rather than to describe a particular order or sequence. It should be understood that data so distinguished may be interchanged, where appropriate, so that embodiments of the disclosure described herein may be implemented in an order other than those illustrated or described herein. Embodiments described in the following examples do not represent all embodiments that are consistent with the disclosure. Rather, they are only examples of devices and methods that are consistent with some aspects of the disclosure, as detailed in the appended claims.

It should be noted herein that “at least one of the several items” in this disclosure includes “any one of the several items”, “any combination of the several items” and “all of the several items” the juxtaposition of these three categories. For example, “including at least one of A and B” includes the following three juxtapositions: (1) including A; (2) including B; (3) including A and B. Another example is “performing at least one of operation one and operation two”, which means the following three juxtapositions (1) performing operation one; (2) performing operation two; (3) performing operation one and operation two.

A log structured merge tree (LSM-Tree) is a hierarchical sorted data storage structure designed for a block storage apparatus which may be used in key-value storage systems. An LSM-Tree a memory table (MemTable), an immutable MemTable (Immutable Mem Table), and a sorted string table (SST). The MemTable may be a data structure of the LSM-Tree which may store the most recent data updated, and may organize the data according to keys. When the Mem Table reaches a certain size, it may be transformed to the Immutable MemTable. The immutable MemTable may be an intermediate state that transforms the Mem Table into an SST file. Write operations may be handled by the new MemTable, and data update operations may be not blocked during the transfer storage process. The set of sorted key-value pairs, which is the data structure of the LSM-Tree in the storage apparatus (e.g., a disk).

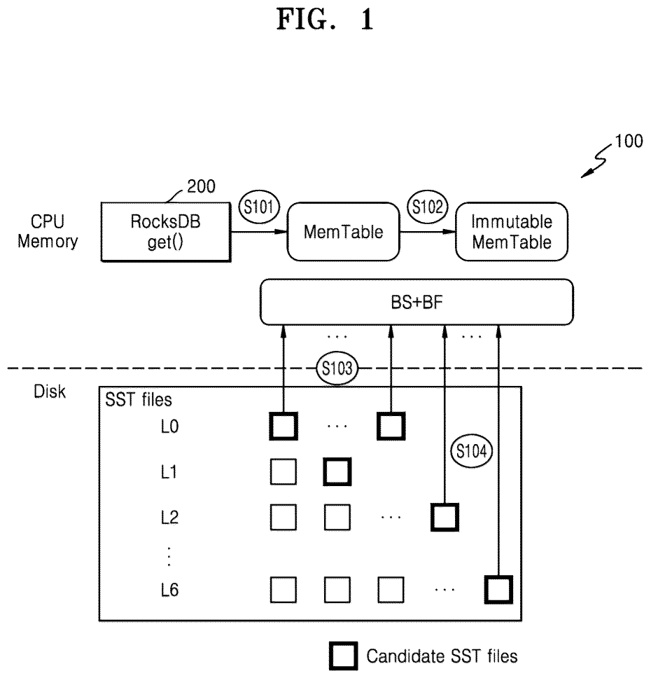

RocksDB may be a database based on the LSM-Tree. In the description below, a RocksDB database may be used an example to illustrate the read operation of the database based on the LSM-Tree, but embodiments are not limited thereto. The data of the RocksDB may be stored hierarchically in the form of SST files inside a storage apparatus (e.g., a disk). According to embodiments, there may be six layers by default, and the size of the SST file of each layer may be ten times of that of the previous layer. FIG. 1 illustrates an example of a read process for RocksDB, according to embodiments. As shown in FIG. 1, a read process of the RocksDB may correspond to a search process of the RocksDB (e.g., Get( )).

For example, at operation S101, a process 100 may including searching for the target key (e.g., the key of the data to be read) in the Mem Table of the host memory;

At operation S102, the process 100 may include searching for the target key in the Immutable Mem Table of the host memory;

Because the keys of the SST files in the L0 layer may overlap, at operation S103, the process 100 may include loading each SST file in the L0 layer sequentially from the storage apparatus to the host for binary search (BS) and bloom filter (BF) checking;

At operation S104, for layer L1 and layers below L1, each time only one of the SST files that may contain the search content (e.g., the target Key) may be acquired for searching, and one candidate file (i.e., the file to be searched) of each layer may be loaded sequentially to the host for the BS and BF checking.

In order to improve the read performance of the LSM-Tree, embodiments may relate to a method to change the serial search into parallel search. For example, according to some approaches, the one thread may be used to search one SST file in one layer at a time, and then at the end, one SST file in the next layer. However, according to embodiments, two threads may be used to search two different SST files in two layers at the same time.

In addition, in order to improve the read performance of the LSM-Tree, embodiments may relate to an eXpress Resubmission Path (XRP). The XRP may reduce an input/output (I/O) stack in the kernel by placing a part of the read operations into the driver layer using extended Berkeley Packet Filter (eBPF) technology, in order to provide improvements to the read performance.

According to embodiments, a potential issue in the read process described above may be that the read amplification may be too large. As an example, an LSM-Tree may include eight SST files in the L0 layer, and there may be another six layers (e.g., layer L1-L6) of the SST files. In addition, at least an index block (which may have a size of, for example, 16 kilobytes (KB)), a filter block (e.g., bloom filter block) (which may have a size of, for example, 4 KB) and a data block (which may have a size of, for example, 4 KB) may be read in each SST file to complete the search. According to this example, for a user to read 1 KB of data, the amount of data read by a processor such as a central processing unit (CPU) may actually be (8+6)*(16+4+4) KB=336 KB. Therefore, the read amplification may be expressed as 336 KB/1 KB=336 times. This read amplification may be too large, which may not only reduce the efficiency of the read operation, but may also increase the CPU occupancy rate and the power consumption of the host.

A parallel search method may provide reduced the latency of the read operation, but the amount of data moved from the storage apparatus to the host may be not reduced, so the read amplification may be not reduced. In addition, the read amplification may be even higher due to the extra SST file which may be read in one layer. For example, in the serial search, if the target key is found in the SST file in the previous layer, the reading of the SST file in the next layer may be stopped, but in the parallel search, the SST file in the next layer may be read in parallel for searching, and the read amplification may therefore be even be higher. In addition, due to the introduction of an additional thread operation, the CPU occupancy rate and the power consumption of the host may be increased.

In addition, the XRP may reduce the IO stack above the driver layer, but the files may still be moved from the storage apparatus to the driver layer at the host, and thus, still fails to solve the problem of the large read amplification.

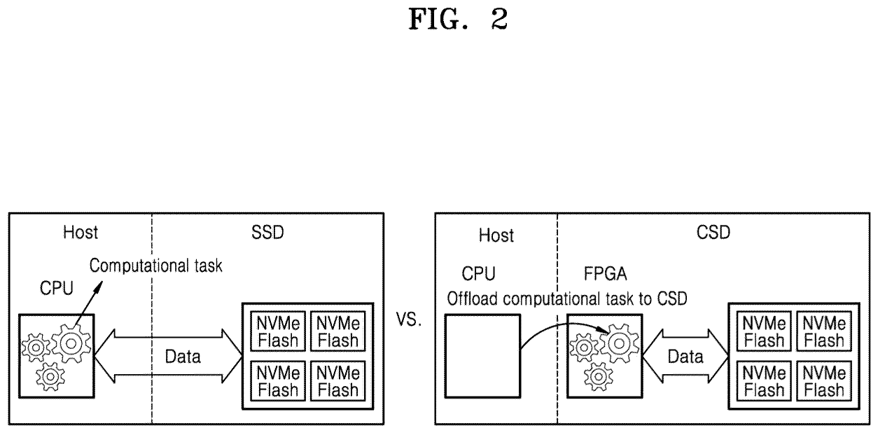

Therefore, embodiments may provide a storage apparatus and a method of reading data for the storage apparatus, which may offload some of the search process into the storage apparatus in order to reduce the data movement between the storage apparatus and the host, which may substantially reduce the read amplification and improve the read performance, and may also reduce the CPU occupancy rate and the power consumption of the host. Hereinafter, examples of a method of reading data for the storage apparatus and the storage apparatus according to embodiments are described with reference to FIGS. 2 to 11.

FIG. 2 illustrates a comparison block diagram between a solid state drive (SSD) and a computational storage drive (CSD) according to an embodiment of the disclosure. The CSD may be a customizable and programmable storage apparatus, for example a Samsung SmartSSD. As shown in FIG. 2, the Field Programmable Gate Array (FPGA) in the CSD may provide a software engineer the ability to program one or more intellectual property (IP) cores or IP blocks that may be used to accelerate a wide range of applications. In comparison with an SSD, a CSD according to embodiments may provide several benefits, for example an ability to offload a CPU, an ability to use hardware for acceleration, and an ability to use near-storage computing to reduce data movement.

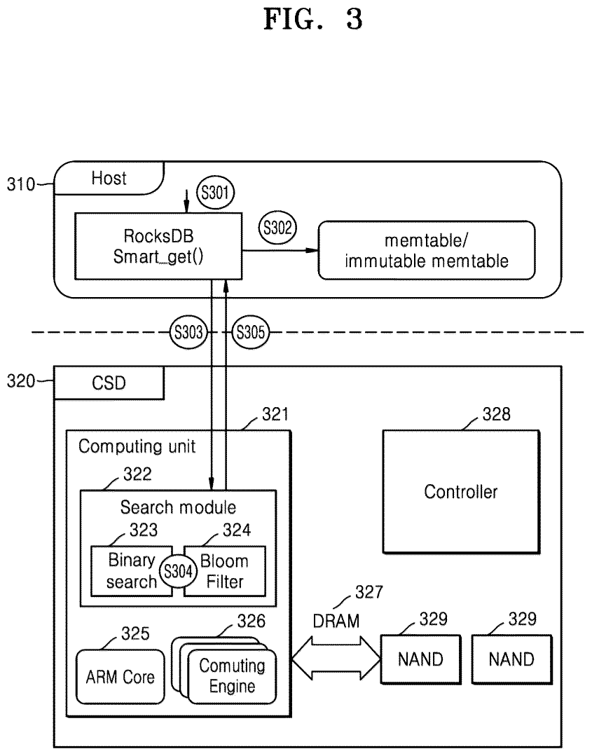

FIG. 3 illustrates an interaction diagram of a host 310 with a storage apparatus such as a CSD 320 regarding a read operation according to an embodiment of the disclosure. According to embodiments, the CSD 320 may include a computing unit 321, which may include a search module 322 including a binary search (BS) module 323 configured to perform a BS algorithm, and a bloom filter (BF) module 324. In some embodiments, as the computing unit 321 may be an FPGA, and the BS module 323 and the BF module 324 may be implemented as IPs which may which may provide two functions for the computing unit 321. The computing unit 321 may also include an ARM core 325, a computing engine 326, and a random access memory (RAM) such as a dynamic RAM (DRAM) 327. The function of the BS module 323 may include binary searching in an index block of an SST file for a data block in which the data to be read is located, and searching for the data to be read in the data block. In addition, the CSD 320 may further include a controller 328 for controlling overall operations of the CSD 320 and one or more NAND devices 329.

In the interaction diagram shown in FIG. 3, after the read request is launched, there may be no need to move the SST file to the host 320 to perform the BS and BF again, because the CSD 320 may load the SST file into the DRAM 327 for the BF and BS using high bandwidth within the CSD 320. Accordingly, only the result may be returned to the host 310. Referring to FIG. 3, taking RocksDB as an example, the interaction between the host 310 and the CSD 320 in the read operation may proceed as follows.

At operation S301 new read interface (e.g., Smart_get) may be added to RocksDB to use the read process of the disclosure.

At operation S302, the read interface may first search for the target key (e.g., the key of the data to be read) in the MemTable and Immutable MemTable in the memory of the host 310, and if it not found, may continue with the following operations.

At operation S303, the host 310 may transmit a search command (which may be referred to as a search request) with the address of the file to be searched (which may be referred to as a candidate file) to the search module 322.

At operation S304, the search module 322 may translate the address and load the corresponding file into the DRAM 327. Then, the BS module 323 and BF module 324 may perform the BS and BF on the file.

At operation S305, the search module 322 may return the search result, a message indicating that the data to be read is not found, or the address of the found target value to the host 310.

If operation S305 above returns the message indicating that the data to be read is not found, the host 310 may transmit another search command (or search request) with the address of a new file to be searched (or new candidate file) and the search may be continued by the CSD 320 until the target key-value is found (e.g., the data to be read) or until the file to be searched at each layer has been traversed.

It Although the computing unit 321 is described above as being implemented by an FPGA, embodiments are not limited thereto. For example, in some embodiments the computing unit 321 may also be implemented by other software, hardware, or a combination of hardware and software. In addition, the internal modules of the computing unit 321 (e.g., the FPGA) and the internal modules of the CSD 320 described above are also only examples, and some modules may be added or deleted, and embodiments are not limited thereto.

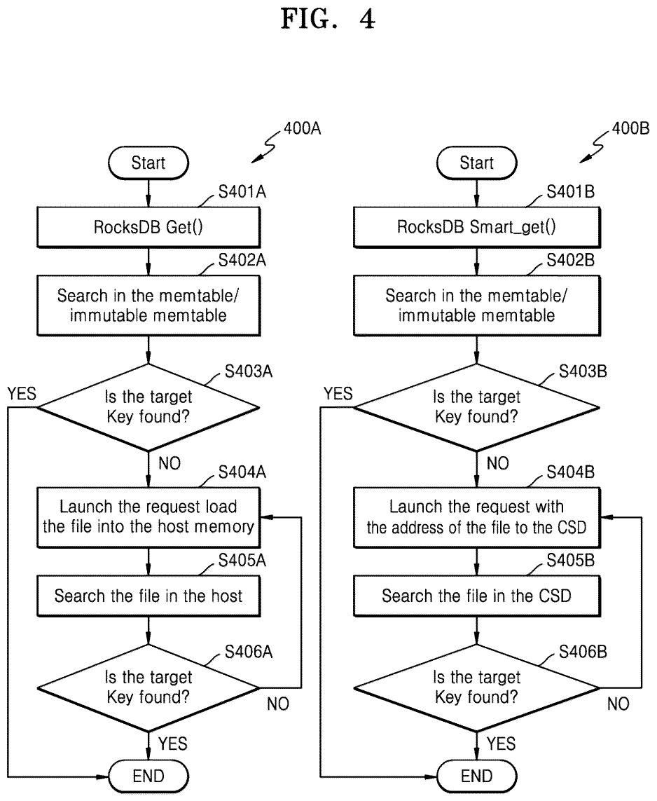

FIG. 4 illustrates flowcharts comparing a comparative example read operation (illustrated as process 400A) with a read operation according to an embodiment of the disclosure (illustrated as process 400B). Referring to FIG. 4, the read operation of the LSM-Tree based database is illustrated using the RocksDB database as an example, and there may be three main differences between the read operation of the disclosure and the existing read operation as labeled in the figure:

At operation S401A, the process 400A may use the interface of Get( )). According to embodiments, at operation S401B, the process 400B may, for example, add a new read interface (e.g., Smart_get( )) to the RocksDB to use a reading method according to embodiments.

According to embodiments, at operations S402A and S402B, the processes 400A and 400B may search in the Mem Table and the Immutable MemTable in the host, and t operations S403A and S403B, the processes 400A and 400B may determine whether the target key is found. If the target key is found, the processes 400A and 400B may end, and if the data to be read is not found, the processes 400A and 400B may proceed to operations S404A and S404B, respectively.

At operation S404A, the process 400A may require frequent loading of the file to be searched from the storage apparatus to the host memory. In contrast, at operation S404B, the host may only transmit the address of the file to be searched to the CSD, which may the file to be searched into the DRAM based on the address. Accordingly, there may be no need to load the file into the host memory.

At operation S405A, the process 400A may include searching for (for example by performing BS and BF on) the loaded file by the host. In contrast, at operation S405B, the process 400B according to an embodiment of the disclosure may use the new added BS module (e.g., the BS module 323) and BF module (e.g., the BF module 324) included in the CSD to search for (for example by performing BS and BF on) the loaded file.

According to embodiments, at operations S406A and S406B, the processes 400A and 400B may include determining whether the target key is found. If the target key is found, the processes 400A and 400B may end, and if the data to be read is not found, the processes 400A and 400B may return to operations S404A and S404B, respectively.

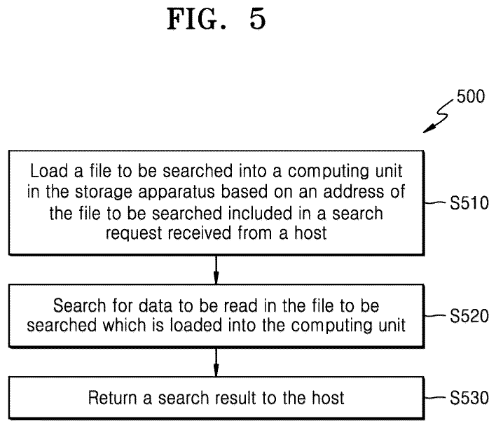

FIG. 5 illustrates a flowchart of a process of data reading for a storage apparatus according to an embodiment of the disclosure. According to embodiments, the process 500 shown in FIG. 5 may be performed by any of the elements discussed above, for example a hose such as the host 310, and a storage apparatus such as the CSD 320, but embodiments are not limited thereto.

Referring to FIG. 5, at operation S510, a file to be searched is loaded into a computing unit in the storage apparatus based on an address of the file to be searched which is included in a search request received from a host. In embodiments, the host may correspond to the host 310 discussed above, and the storage apparatus may correspond to the CSD 320 discussed above, but embodiments are not limited thereto.

A database (e.g., RocksDB) based on LSM-Tree may add a read interface (e.g., Smart_get( )). After a read request is Launched, for example, the read interface may be used (e.g., invoked by the host) to launch the read request, the read interface may first search for the data to be read (e.g., the target key) in the Mem Table and Immutable Mem Table in the memory of the host, and, if it is not found, may subsequently search for the data to be read in the SST file.

According to an embodiment of the disclosure, the search request may be transmitted by the host by invoking the read interface in the database.

The read interface (e.g., Smart_get( )) invoked by the host may transmit the search request including the address of the file to be searched to the storage apparatus to instruct the storage apparatus to search for the data to be read in the corresponding file. The storage apparatus may load the file to be searched into a computing unit in the storage apparatus based on the address of the file to be searched which is included in the search request received from the host. Specifically, the storage apparatus may perform a translation (e.g., a logical to physical address translation) of the address of the file to be searched included in the search request, and then may load the file to be searched into the computing unit in the storage apparatus based on the translated address. Here, other parameters, for example, the key of the data to be read (e.g., the target key), etc., may be included in the search request to instruct the storage apparatus to perform the search for the data to be read (e.g., the target key) in the file to be searched.

According to an embodiment of the disclosure, the computing unit may include a dynamic random access memory DRAM, and the file to be searched may be loaded into the DRAM included in the computing unit.

In an embodiment of the disclosure, the computing unit may be, for example, the computing unit 321 included in the CSD 320 as shown in FIG. 3. The computing unit 321 may be, for example, an FPGA, and the CSD 320 may include the DRAM 327, and the file to be searched may be loaded, for example, from a flash NAND 329 included in the CSD 320 to the DRAM 327.

According to an embodiment of the disclosure, the file to be searched may be an SST file stored hierarchically in a database based on an LSM-Tree.

For example, the file to be searched may be all SST files in the L0 layer or one SST file in L1-L6 that may contain data to be read (e.g., a target key). The search may start from L0 and proceed through L6. For example, there may be eight SST files in layer L0, and there may be another six layers (e.g., layers L1-L6) of SST files. Accordingly, a total number of the files to be searched may be 8+6=14. In an embodiment of the disclosure, a read interface invoked by a host may transmit the address of one SST file to be searched to the storage apparatus at a time.

At operation S520, the data to be read may be searched for in the file to be searched which is loaded into the computing unit.

According to an embodiment of the disclosure, an index block and a filter block in the SST file to be searched may be loaded into the computing unit. In embodiments, the index block may include index information about data blocks in the SST file to be searched. A data block in which the data to be read is likely located may be determined based on the index block loaded into the computing unit. In embodiments, the data block in which the data to be read is likely located may be referred to as a candidate data block. In embodiments, operation S520 may further include determining whether the data to be read exists in the data block based on the filter block loaded into the computing unit. Based on determining that the data to be read exists in the data block, the data block in the SST file to be searched may be loaded into the computing unit; and the data to be read may be searched for in the data block loaded into the computing unit.

In an embodiment of the disclosure, the SST file may include an index block, a filter block, and data blocks, wherein the index block includes index information of the data blocks, and the filter block includes filtered data corresponding to the data blocks. The filter block may for example be a bloom filter block, and the filtered data may be a bit array of the bloom filter, and number of the bit array of the bloom filter may be the same as the number of data blocks. Records of the index block may use, for example, a form of “key: offset: size”, in which the key may indicate the minimum key (or maximum key) of each data block, the offset may indicate the starting position of the data block, and the size may indicate the size of each data block. The data blocks may be stored in a sequential manner, which may facilitate performing a binary search on the index block to find the corresponding data block. In order to accelerate the efficiency of the data search in the SST file, before directly searching the contents in the data block, it may be determined whether the data to be searched exists in the data block based on the filtered data in the filter block, and if it is determined that it does not exist, there may be no need to perform the search of the entire data block.

According to an embodiment of the disclosure, the data block in which the data to be read is likely located may be found through a binary search in the index block, and the determination of whether the data to be read exists in the data block may be made using a bloom filter based on the filter block loaded into the computing unit.

In an embodiment of the disclosure, the index block and the filter block of the file to be searched (e.g., the SST file) may be loaded into the computing unit first, and because the index block may include the index information of the data blocks, the candidate data block may be found by the binary search in the index block. For example, the offset and size of the data block in which the data to be read (e.g., the target key) is likely located may be found using key lookup and comparison. In order to accelerate the efficiency of the data search in the file to be searched (e.g., the SST file), before directly searching the contents of the data block, the filtered data corresponding to the data block in the filter block may be obtained according to the candidate data block, for example, the bit array of the bloom filter corresponding to the data block in the filter block may be obtained, and checking whether the data to be read exists in the data block through the bloom filter. In some embodiments, the binary search may be performed using the BS module 323 included in the computing unit 321 included in the CSD 320 as shown in FIG. 3, and the bloom filter may be performed using the BF module 324 included in the computing unit 321.

According to an embodiment of the disclosure, a plurality of hash values for a key of the data to be read (e.g., the target key) may be calculated using a plurality of hash functions, and the determination of whether the data to be read exists in the data block may be made by matching the plurality of hash values with a data structure in the filter block.

A bloom filter may refer to a data structure used to check whether an element is in a set. The bloom filter may complete the element check using a bit array (e.g., a bitmap) and a set of hash functions. When adding an element, the added element may be mapped to k positions (where k is a positive integer) of the bit array using k hash functions. In embodiments, the bit array may be initialized to a value of “0”, and the values of the k positions may be set to “1”. For example, three hash operations may be performed on the string of “hello world” using three hash functions, the obtained three hash values may be “2”, “5” and “8”, and the values of these three positions (e.g., positions 2, 5 and 8) in the bit array may be set to “1”. When checking the existence of an element, likewise, the element to be checked may be mapped to the k positions of the bit array through the k hash functions, and whether the query element exists in the set may be known by determining whether the values of the k positions in the bit array are all “1”. According to embodiments, if the value of any of these positions is “0”, the element being checked must not exist; and if the values of all of these positions are “1”, the element being checked may exist. For example, checking for the existence of “hello world” may include the hash function operations of adding an element, obtaining the hash values of “2”, “5”, and “8”, and checking whether the values of the corresponding positions in the bit array are all “1”.

In an embodiment of the disclosure, the plurality of hash functions of the bloom filter may be utilized to calculate the plurality of hash values of the key of the data to be read, respectively, and then the calculated plurality of hash values may be matched with the data structure in the filter block. The data structure here may be the bit array of the bloom filter corresponding to the data block in the filter block, and the data block may be the data block where the data to be read is likely located. For example, it may be determined whether the values of the positions of the plurality of hash values in the bit array are all “1”, to determine whether the data to be read exists in that data block. For example, based on the values of the positions of the plurality of hash values in the bit array are all “1” (which may indicate a match), it may be determined that the data to be read exists in that data block, and if any of those positions are “0” (which may indicate a mismatch), it may be determined that the data to be read does not exist in that data block.

If it is determined by the bloom filter that the data to be read exists in the data block, the data block in the SST file to be searched may be loaded into the computing unit. For example, the data block in the SST file to be searched may be loaded from the flash NAND 329 in the CSD 320 to the DRAM 327 in the computing unit 321 according to the offset and size of the data block obtained as described above, and the data to be read may be searched for in the data block loaded into the computing unit 321. Here, the search method of searching for the data to be read in the data block is not limited to the examples described above, and may also be performed by the BS module 323 in the computing unit 321 in the CSD 320 as shown in FIG. 3. If it is determined by the bloom filter that the data to be read does not exist in the data block, the search of the SST file to be searched may be ended, and the storage apparatus may return a message indicating that the data is not found to the host.

At operation S530, the search result may be returned to the host.

According to an embodiment of the disclosure, in response to the data to be read being found in the file to be searched, an address of the data to be read is returned to the host, and in response to the data to be read not being found in the file to be searched, a message indicating that the data is not found may be returned to the host.

In an embodiment of the disclosure, if the data to be read is found in the file to be searched, the storage apparatus may return the address of the data to be read to the host. According to embodiments, the address may be an address of the target value, for example, the address in a NAND device. After the host receives the address of the data to be read from the storage apparatus, the search for the data to be read may be ended and the data may be read by the host. If the data to be read is not found in the file to be searched, the storage apparatus may transmit a message indicating that the data is not found to the host.

According to an embodiment of the disclosure, after returning the message indicating that the data is not found to the host, in response to receiving the search request from the host that includes the address of the file to be searched, the process 500 may include returning to the loading of the file to be searched into the computing unit in the storage apparatus based on the address of the file to be searched included in the search request received from the host, wherein the address of the file to be searched is the address of a new file to be searched.

According to an embodiment of the disclosure, the searching for the data to be read is ended in the case where the message indicating that the data is not found is received by the host and the file to be searched has been traversed, or the address of the data to be read is received by the host.

In an embodiment of the disclosure, after receiving the message indicating that the data is not found, if the file to be searched has not been traversed, the host may continue by transmitting a search request including the address of a new file to be searched to the storage apparatus. In an example in which the RocksDB is used, if the SST file to be searched has not been traversed to one possible SST file in the last layer (e.g., a layer L6), the host may transmit the search request (e.g., a new search request) including the address of the next SST file to be searched to the storage apparatus, instructing the storage apparatus to continue the search. Upon receiving the new search request, the storage apparatus may repeat the above operation S510 to operation S530. If the file to be searched has been traversed, for example, has been traversed to one possible SST file in the last layer of the RocksDB (e.g., the layer L6), the searching for the data to be read may be ended, and no further search request may be transmitted to the storage apparatus with respect to that data to be read.

According to the method of data reading for a storage apparatus of the disclosure, the high bandwidth within the storage apparatus may be fully utilized to load the file to be searched into the storage apparatus, which may greatly reduce the data movement between the storage apparatus and the host, and may significantly reduce the read amplification. In addition, the binary search module and the bloom filter module implemented within the storage apparatus may be utilized for the search of the file to be searched, which may not only improve the search efficiency, but may also reduce CPU occupancy rate and power consumption of the host.

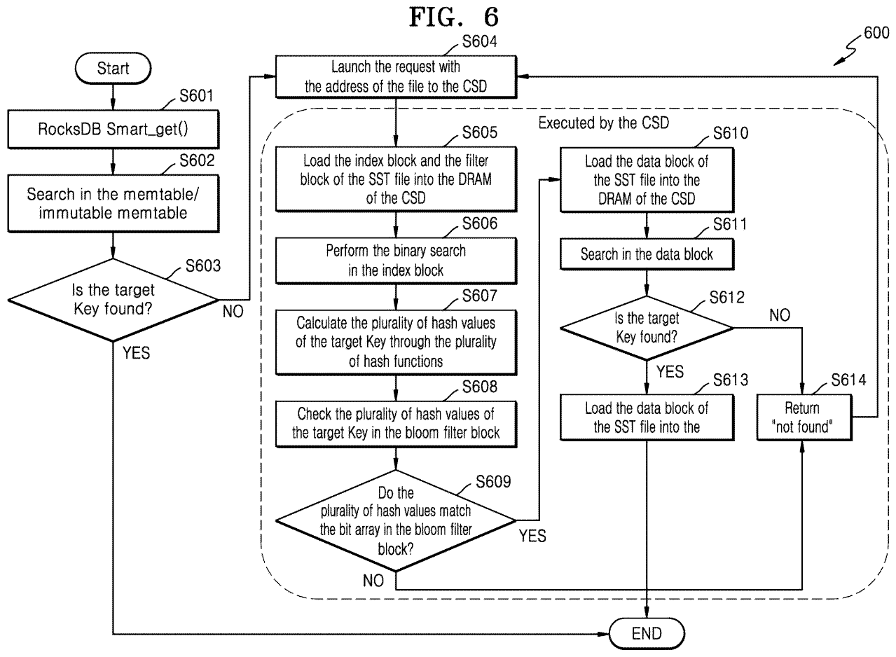

FIG. 6 illustrates a detailed flowchart of data reading process 600 according to an embodiment of the disclosure. According to embodiments, the process 600 may be performed by any of the elements discussed above, for example a hose such as the host 310, and a storage apparatus such as the CSD 320, but embodiments are not limited thereto.

According to the data reading process 600 of the disclosure at operation S601, the read interface may be invoked by the host to launch the read request for the data to be read, and the read interface may be, for example, the read interface Smart_get( ) added by RocksDB. At operation S602, the read interface may search in the MemTable and the Immutable Mem Table included in the host memory for the target key (e.g., the key of the data to be read). At operation S603, if the target key is found (YES at operation S603), the process 600 may end, if not (NO at operation S603), the process 600 may proceed to operation S604. At operation S604, the read interface may transmit the search request with the address of the file to be searched to the storage apparatus (e.g., the CSD 320).

In embodiments, the operations S605 through S614 described below may be performed by the storage apparatus:

At operation S605, the storage apparatus may load the index block and the filter block (e.g., a bloom filter block) of the file (e.g., the SST file) to be searched into the DRAM (e.g., DRAM in a computing unit) in the storage apparatus based on the address of the file to be searched.

At operation S606, the binary search may be performed in the index block loaded into the DRAM to find the data block where the data to be read is likely located.

At operation S607, the plurality of hash values of the target key may be calculated through the plurality of hash functions of the bloom filter.

At operation S608, the plurality of hash values of the target key may be checked in the bloom filter block to determine whether the data to be read exists in the data block.

At operation S609, if the plurality of hash values does not match the bit array in the bloom filter block (NO at operation S609), the search of the file to be searched may be ended, the process 600 may proceed to operation S614) to return the message indicating that the data is not found to the host, and if the plurality of hash values match the bit array in the bloom filter (YES at operation S609), the process 600 may proceed to operation S610.

At operation S610, the data block of the file to be searched may be loaded into the DRAM in the storage apparatus (e.g., the DRAM in the computing unit).

At operation S611, the target key (e.g., the key of the data to be read) may be searched for in the data block loaded into the DRAM.

At operation S612, if the target key is found (YES at operation S612), the process 600 may proceed to operation S613, and if not (NO at operation S612), the process 600 may proceed to operation S614.

At operation S613, the storage apparatus may return the address of the target value (e.g., the address of the value of the data to be read) to the host.

At operation S614, the storage apparatus may return the message indicating that the data is not found to the host.

After operation S614, the process 600 may return to operation S604. For example, after the host receives the message indicating that the data is not found, which may be returned from the storage apparatus, if the file to be searched has not been traversed, the read interface in operation S604 may transmit the search request to the storage apparatus that includes the address of a new file to be searched, so that the storage apparatus may repeat operations S605 to S614 to complete the search of the new file to be searched, until the data to be read is found or the file to be searched has been traversed.

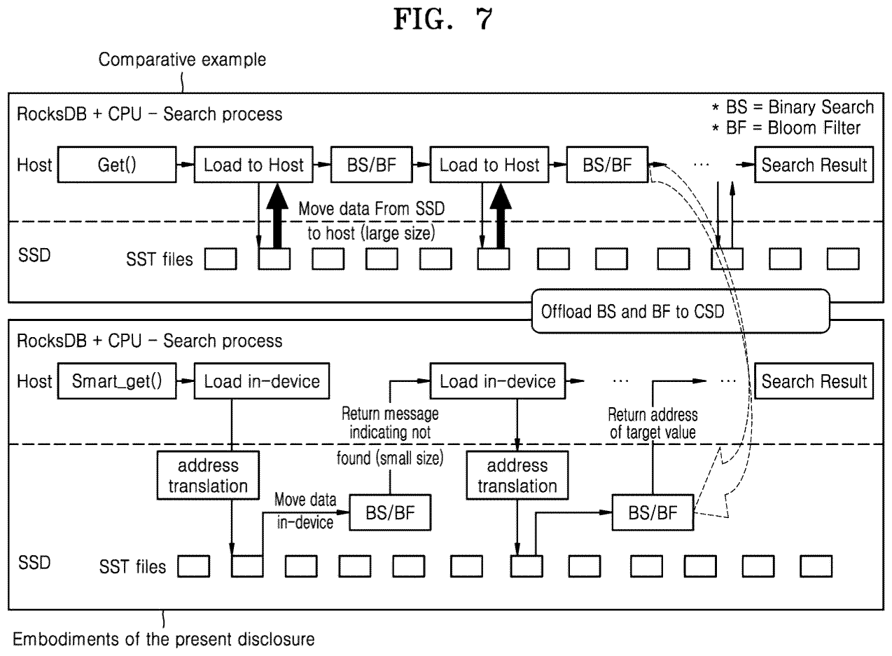

FIG. 7 illustrates a data flow comparison between the disclosure and a comparative example according to an embodiment of the disclosure.

In the comparative example, in the search process of the SST file (taking the RocksDB as an example, using the Get( ) interface), the SST files to be searched may be loaded from the storage apparatus (e.g., an SSD) to the host, the amount of data moved may be large, and the BS and BF operations may be performed on the loaded SST files at the host.

In contrast, according to embodiments of the present disclosure, in the search process of the SST file (taking the RocksDB as an example, using the newly added Smart_Get( ) interface), the host may transmit the search request including the address of the SST file to be searched to the storage apparatus (e.g., a CSD). The storage apparatus may load the SST file to be searched into the storage apparatus (e.g., in DRAM) based on the address of the SST file to be searched after the address translation, and performs the BS and BF operations on the loaded SST file within the storage apparatus. Accordingly, the BS and BF operations may be offloaded to the storage apparatus. If the data to be read is not found, the storage apparatus returns the message (a small amount of data) indicating that the data to be read is not found to the host, and the host after receiving the message may transmit the search request to the storage apparatus including the address of a new SST file to be searched. The storage apparatus may load the new SST file to be found into the storage apparatus according to the address of the new SST file to be found after the address translation, and perform BS and BF operations on the loaded SST file within the storage apparatus. If found, the storage apparatus returns the address of the target value to the host.

It Although examples are described above in which the storage apparatus is a CSD embodiments are not limited thereto.

An example comparison between the comparative example and embodiments according to the present disclosure are shown in Table 1 below:

TABLE 1

| | Embodiments of the |
|---|---|
| Comparative example | present disclosure |
| Massive data movement | Reduced data movement |
| Underutilized high on- | Greater utilization of |
| disk bandwidth | high on-disk bandwidth |
| High CPU occupancy rate | Reduced CPU utilization |
| High power consumption | Reduced power consumption |

As discussed above, a read process according to the comparative example may involve moving at least 24 KB of data for each SST file, while a read process according to embodiments of the disclosure may only return one result after the search of each SST file. According to the calculation that the size of a completion command of nonvolatile memory express (NVMe) SSD may be 16B, the read amplification according to embodiments of the disclosure may be ((8+6)*16B+1 KB)/1 KB=1.22 times. Compared with the 336 times of read amplification according to the comparative example, embodiments may provide greatly reduced read amplification.

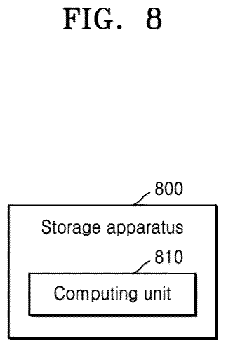

FIG. 8 illustrates a block diagram of an internal module of a storage apparatus according to an embodiment of the disclosure.

Referring to FIG. 8, the storage apparatus 800 may include a computing unit 810, which may be configured to load a file to be searched into the computing unit 810 in the storage apparatus 800 based on an address of the file to be searched included in a search request received from a host; obtain a search result by searching for data to be read in the file to be searched which is loaded into the computing unit 810; and return the search result to the host. In embodiments, the storage apparatus 800 may correspond to the CSD 320 discussed above, and the computing unit 810 may correspond to the computing unit 321 discussed above, but embodiments are not limited thereto.

According to an embodiment of the disclosure, the file to be searched may be a sorted string table (SST) file stored hierarchically in a database based on an LSM-Tree.

According to an embodiment of the disclosure, the computing unit 810 may be further configured to: load an index block and a filter block in the SST file to be searched into the computing unit 810, wherein the index block includes index information of data blocks in the SST file to be searched, determine a data block in which the data to be read is likely located based on the index block loaded into the computing unit 810; determine whether the data to be read exists in the data block based on the filter block loaded into the computing unit 810; in response to the data to be read existing in the data block, load the data block in the SST file to be searched into the computing unit 810; and search for the data to be read in the data block loaded into the computing unit 810.

According to an embodiment of the disclosure, the computing unit 810 may be further configured to: find, through a binary search in the index block, the data block in which the data to be read is likely located, check whether the data to be read exists in the data block through a bloom filter based on the filter block loaded into the computing unit 810.

In an embodiment of the disclosure, the computing unit 810 may include a binary search module and a bloom filter module. The binary search module may be configured to find, through a binary search in the index block, the data block in which the data to be read is likely located, and to search for the data to be read in the data block loaded into the computing unit 810. The bloom filter module may be configured to check whether the data to be read exists in the data block by a bloom filter based on the filter block loaded to the computing unit 810.

According to an embodiment of the disclosure, the computing unit 810 may be further configured to: calculate a plurality of hash values for a key of the data to be read using a plurality of hash functions; check whether the data to be read exists in the data block by matching the plurality of hash values with a data structure in the filter block.

According to an embodiment of the disclosure, the computing unit 810 may be further configured to: return, in response to the data to be read being found in the file to be searched, an address of the data to be read to the host; return, in response to the data to be read not being found in the file to be searched, a message indicating that the data is not found to the host.

According to an embodiment of the disclosure, after returning the message indicating that the data is not found to the host, in response to receiving the search request from the host that includes the address of the file to be searched, the storage apparatus 800 may be further configured to return to the operation of loading the file to be searched into the computing unit 810 based on the address of the file to be searched being included in the search request received from the host, wherein the address of the file to be searched is the address of a new file to be searched.

According to an embodiment of the disclosure, the searching for the data to be read may be ended in the case where the message indicating that the data is not found was received by the host and the file to be searched has been traversed, or the address of the data to be read is received by the host.

According to an embodiment of the disclosure, the search request may be transmitted by the host by invoking a read interface in the database.

According to an embodiment of the disclosure, the computing unit 810 may include a dynamic random access memory (DRAM), and the computing unit may be further configured to: load the file to be searched into the DRAM.

Therefore, according to embodiments of the disclosure, the high bandwidth within the storage apparatus 800 may be fully utilized to load the file to be searched into the storage apparatus, which may greatly reduce the data movement between the storage apparatus 800 and the host, and may significantly reduce the read amplification. In addition, the binary search module and the bloom filter module implemented within the storage apparatus 800 may be utilized for the search of the file to be searched, which may improve the search efficiency, and may also reduce CPU occupancy rate and the power consumption of the host.

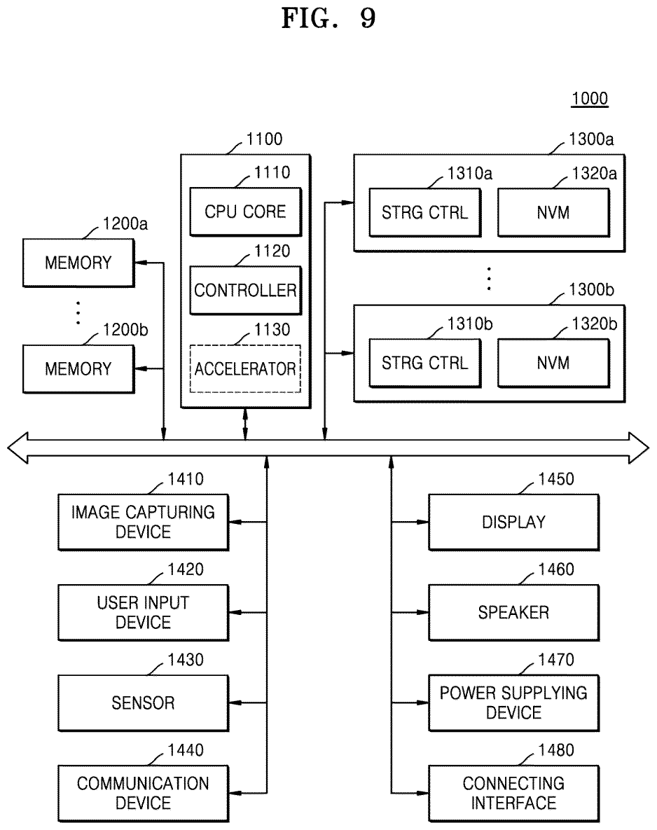

FIG. 9 is a diagram of a system 1000 to which a storage device is applied, according to an embodiment.

The system 1000 of FIG. 9 may basically be a mobile system, such as a portable communication terminal (e.g., a mobile phone), a smartphone, a tablet personal computer (PC), a wearable device, a healthcare device, or an Internet of things (IoT) device. However, the system 1000 of FIG. 9 is not necessarily limited to the mobile system and may be a PC, a laptop computer, a server, a media player, or an automotive device (e.g., a navigation device).

Referring to FIG. 9, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some embodiments, the main processor 1100 may further include an accelerator 1130, which may be a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or DRAM, each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (illustrated as “STRG CTRL”) 1310a and 1310b as well as non-volatile memory (NVM) 1320a and NVM 1320b configured to store data via the control of the storage controllers 1310a and 1310b. Although the NVMs 1320a and 1320b may include flash memories having a two-dimensional (2D) structure or a three-dimensional (3D) vertical NAND (V-NAND) structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of solid-state devices (SSDs) or memory cards and be removably combined with other components of the system 1000 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), may be applied, without being limited thereto.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

According to an embodiment of the disclosure, a system (e.g., the system 1000), to which a storage apparatus is applied, is provided, the system includes a main processor (e.g., the main processor 1100); a memory (e.g., the memories 1200a and 1200b); and the storage apparatus (e.g., the storage devices 1300a and 1300b), wherein the storage apparatus is configured to perform the method of data reading for the storage apparatus as described above.

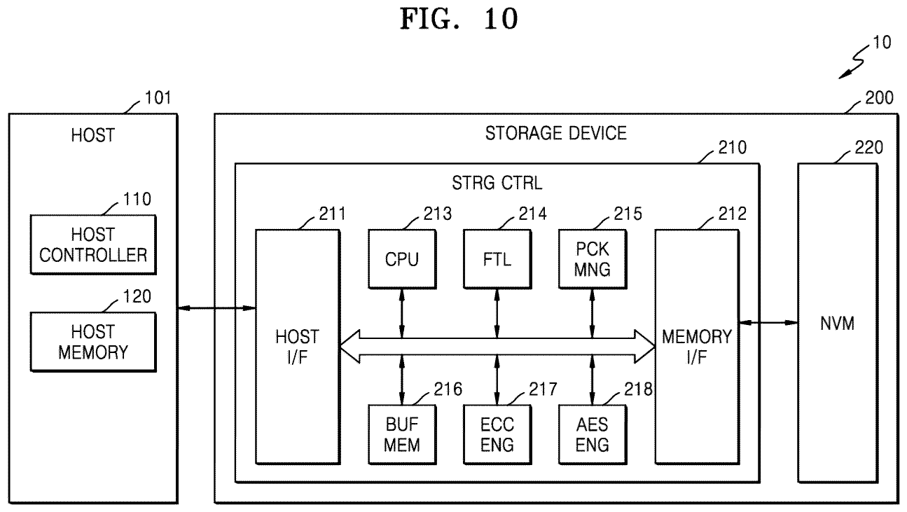

FIG. 10 is a block diagram of a host storage system 10 according to an example embodiment.

The host storage system 10 may include a host 101 and a storage device 200. Further, the storage device 200 may include a storage controller 210 and an NVM 220. According to an example embodiment, the host 101 may include a host controller 110 and a host memory 120. The host memory 120 may serve as a buffer memory configured to temporarily store data to be transmitted to the storage device 200 or data received from the storage device 200.

The storage device 200 may include storage media configured to store data in response to requests from the host 101. As an example, the storage device 200 may include at least one of an SSD, an embedded memory, and a removable external memory. When the storage device 200 is an SSD, the storage device 200 may be a device that conforms to an NVMe standard. When the storage device 200 is an embedded memory or an external memory, the storage device 200 may be a device that conforms to a UFS standard or an eMMC standard. Each of the host 101 and the storage device 200 may generate a packet according to an adopted standard protocol and transmit the packet.

When the NVM 220 of the storage device 200 includes a flash memory, the flash memory may include a 2D NAND memory array or a 3D NAND (or V-NAND) memory array. As another example, the storage device 200 may include various other kinds of NVMs. For example, the storage device 200 may include magnetic RAM (MRAM), spin-transfer torque MRAM, conductive bridging RAM (CBRAM), ferroelectric RAM (FRAM), PRAM, RRAM, and various other kinds of memories.

According to an embodiment, the host controller 110 and the host memory 120 may be implemented as separate semiconductor chips. In some embodiments, the host controller 110 and the host memory 120 may be integrated in the same semiconductor chip. As an example, the host controller 110 may be any one of a plurality of modules included in an application processor (AP). The AP may be implemented as a System on Chip (SoC). Further, the host memory 120 may be an embedded memory included in the AP or an NVM or memory module located outside the AP.

The host controller 110 may manage an operation of storing data (e.g., write data) of a buffer region of the host memory 120 in the NVM 220 or an operation of storing data (e.g., read data) of the NVM 220 in the buffer region.

The storage controller 210 may include a host interface 211, a memory interface 212, and a CPU 213. Further, the storage controllers 210 may further include a flash translation layer (FTL) 214, a packet manager 215, a buffer memory 216, an error correction code (ECC) engine 217, and an advanced encryption standard (AES) engine 218. The storage controllers 210 may further include a working memory (not shown) in which the FTL 214 is loaded. The CPU 213 may execute the FTL 214 to control data write and read operations on the NVM 220.

The host interface 211 may transmit and receive packets to and from the host 101. A packet transmitted from the host 101 to the host interface 211 may include a command or data to be written to the NVM 220. A packet transmitted from the host interface 211 to the host 101 may include a response to the command or data read from the NVM 220. The memory interface 212 may transmit data to be written to the NVM 220 to the NVM 220 or receive data read from the NVM 220. The memory interface 212 may be configured to comply with a standard protocol, such as Toggle or open NAND flash interface (ONFI).

The FTL 214 may perform various functions, such as an address mapping operation, a wear-leveling operation, and a garbage collection operation. The address mapping operation may be an operation of converting a logical address received from the host 101 into a physical address used to actually store data in the NVM 220. The wear-leveling operation may be a technique for preventing excessive deterioration of a specific block by allowing blocks of the NVM 220 to be uniformly used. As an example, the wear-leveling operation may be implemented using a firmware technique that balances erase counts of physical blocks. The garbage collection operation may be a technique for ensuring usable capacity in the NVM 220 by erasing an existing block after copying valid data of the existing block to a new block.

The packet manager 215 may generate a packet according to a protocol of an interface, which consents to the host 101, or parse various types of information from the packet received from the host 101. In addition, the buffer memory 216 may temporarily store data to be written to the NVM 220 or data to be read from the NVM 220. Although the buffer memory 216 may be a component included in the storage controllers 210, the buffer memory 216 may be outside the storage controllers 210.

The ECC engine 217 may perform error detection and correction operations on read data read from the NVM 220. More specifically, the ECC engine 217 may generate parity bits for write data to be written to the NVM 220, and the generated parity bits may be stored in the NVM 220 together with write data. During the reading of data from the NVM 220, the ECC engine 217 may correct an error in the read data by using the parity bits read from the NVM 220 along with the read data, and output error-corrected read data.

The AES engine 218 may perform at least one of an encryption operation and a decryption operation on data input to the storage controllers 210 by using a symmetric-key algorithm.

According to an embodiment of the disclosure, a host storage system (e.g., the host storage system 10) is provided, the host storage system includes a host (e.g., 100); and a storage device (e.g., the storage device 200), wherein the storage device is configured to perform the method of data reading for the storage device as described above.

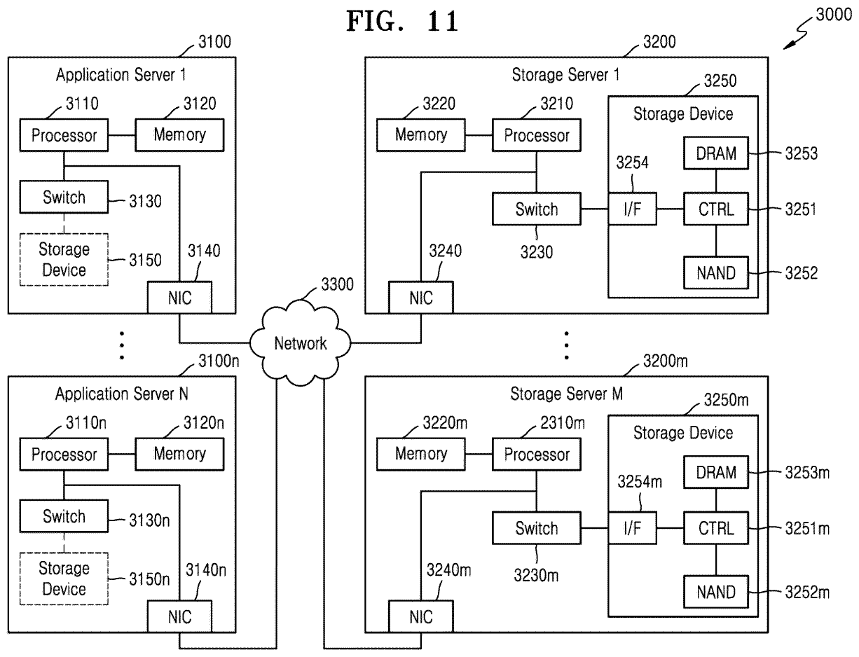

FIG. 11 is a diagram of a data center 3000 to which a memory device may be applied, according to an embodiment.

Referring to FIG. 11, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to embodiments. The number of application servers 3100 to 3100n may be different from the number of storage servers 3200 to 3200m.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some embodiments, the numbers of processors 3210 and memories 3220 included in the storage server 3200 may be variously selected. In an embodiment, the processor 3210 and the memory 3220 may provide a processor-memory pair. In an embodiment, the number of processors 3210 may be different from the number of memories 3220. The processor 3210 may include a single-core processor or a multi-core processor. The above description of the storage server 3200 may be similarly applied to the application server 3100. In some embodiments, the application server 3100 may not include a storage device 3150. The storage server 3200 may include at least one storage device 3250. The number of storage devices 3250 included in the storage server 3200 may be variously selected according to embodiments.

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In an embodiment, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In another embodiment, the network 3300 may be a general network, such as a TCP/IP network. For example, the network 3300 may be implemented according to a protocol, such as FC over Ethernet (FCOE), network attached storage (NAS), and NVMe over Fabrics (NVMe-oF).

Below, examples of the application server 3100 and the storage server 3200 are described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

An example of the storage server 3200 is described below. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC (Network InterConnect) 3240. The switch 3230 may selectively connect the processor 3210 to the storage device 3250 or selectively connect the NIC 3240 to the storage device 3250 via the control of the processor 3210.

In an embodiment, the NIC 3240 may include a network interface card and a network adaptor. The NIC 3240 may be connected to the network 3300 by a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In an embodiment, the NIC 3240 may be integrated with at least one of the processor 3210, the switch 3230, and the storage device 3250.

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

The controller 3251 may control all operations of the storage device 3250. In an embodiment, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

According to an exemplary embodiment of the disclosure, a data center system (e.g., the data center system 3000) is provided, the data center system includes a plurality of application servers (e.g., the application servers 3100 to 3100n); and a plurality of storage servers (e.g., the storage servers 3200 to 3200m), wherein each storage server includes a storage apparatus, wherein the storage apparatus is configured to perform the method of data reading for the storage apparatus as described above.

According to an exemplary embodiment of the disclosure, a computer readable storage medium having a computer program stored thereon is provided, wherein the computer program when executed by a processor implements the method of data reading for the storage apparatus as described above. Examples of computer-readable storage media herein include: read-only memory (ROM), random access programmable read-only memory (PROM), electrically erasable programmable read-only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disk memory, hard disk drive (HDD), SSD, card-based memory (such as, for example multimedia cards, Secure Digital (SD) cards and/or Extreme Digital (XD) cards), magnetic tapes, floppy disks, magneto-optical data storage devices, optical data storage devices, hard disks, solid state disks, and/or any other device, where the other device is configured to store the computer programs and any associated data, data files, and/or data structures in a non-transitory manner and to provide the computer programs and any associated data, data files, and/or data structures to a processor or computer, so that the processor or computer may execute the computer program. The computer program in the computer readable storage medium may run in an environment deployed in a computer device such as for example a terminal, client, host, agent, server, etc., and in one example, the computer program and any associated data, data files and/or data structures are distributed on a networked computer system such that the computer program and any associated data, data files and/or data structures are stored, accessed, and/or executed in a distributed manner by one or more processors or computers.

In a storage apparatus and a method of data reading for the storage apparatus according to an embodiment of the disclosure, the high bandwidth within the storage apparatus may be fully utilized to load the file to be searched into the storage apparatus, which may greatly reduce the data movement between the storage apparatus and the host, and may significantly reduce the read amplification. In addition, the BS module and the BF module implemented within the storage apparatus may be utilized for the search of the file to be searched, which may improve the search efficiency, and may also reduce CPU occupancy rate and power consumption of the host.

While some embodiments of the disclosure are specifically shown and described above, it will be understood by those of ordinary skill in the art that various changes in form and detail may be made therein without departing from the spirit and scope of the disclosure as defined by the appended claims.

1. A method of data reading for a storage device, the method comprising:
receiving a search request from a host, the search request comprising an address of a file to be searched;
loading the file into a computing unit included in the storage device based on the address;
obtaining a search result by searching for data to be read in the file; and
returning the search result to the host.

2. The method of claim 1, wherein the file comprises a sorted string table (SST) file which is stored hierarchically in a database based on a log structured merge tree (LSM-Tree).

3. The method of claim 2, wherein the loading of the file comprises loading an index block and a filter block included in the SST file into the computing unit,
wherein the index block comprises index information about data blocks in the SST file, and
wherein the searching for the data in the file comprises:
determining a candidate data block based on the index block;
determining whether the data exists in the candidate data block based on the filter block;
based on determining that the data exists in the candidate data block, loading the candidate data block into the computing unit; and
searching for the data in the candidate data block.

4. The method of claim 3, wherein the candidate data block is determined using a binary search in the index block, and
wherein the determining of whether the data exists in the candidate data block comprises: checking whether the data exists in the candidate data block using a bloom filter based on the filter block.

5. The method of claim 4, wherein the checking of whether the data exists in the candidate data block comprises:
calculating a plurality of hash values corresponding to a key of the data using a plurality of hash functions; and
matching the plurality of hash values with a data structure in the filter block.

6. The method of claim 1, wherein the returning of the search result to the host comprises:
based on the data being found in the file, returning an address of the data to the host;
based on the data not being found in the file, a message indicating that the data is not found to the host.

7. The method of claim 6, further comprising:
after returning the message to the host, receiving a new search request from the host, wherein the new search request comprises a new address of a new file to be searched; and
loading of the new file into the computing unit based on the new address.

8. The method of claim 7, wherein the searching for the data is ended based on the message being received by the host and the file being traversed, or based on the address of the data being received by the host.

9. The method of claim 2, wherein the search request is transmitted by the host by invoking a read interface in the database.

10. The method of claim 1, wherein the computing unit comprises a dynamic random access memory (DRAM), and
wherein the loading of the file into the storage device comprises: loading the file into the DRAM.

11. A storage apparatus comprising:
at least one processor configured to implement a computing unit,
wherein the computing unit is configured to:
obtain a search request received by the storage apparatus from a host, wherein the search request comprises an address of a file to be searched,
load the file into the computing unit based on the address,
obtain a search result by searching for data to be read in the file, and
return the search result to the host.

12. The storage apparatus of claim 11, wherein the file comprises a sorted string table (SST) file which is stored hierarchically in a database based on a log structured merge tree (LSM-Tree).

13. The storage apparatus of claim 12, wherein the computing unit is further configured to:
load an index block and a filter block included in the SST file into the computing unit, wherein the index block comprises index information about data blocks in the SST file,
determine a candidate data block based on the index block;
determine whether the data exists in the candidate data block based on the filter block;
based on determining that the data exists in the candidate data block, load the candidate data block into the computing unit; and
search for the data in the candidate data block.

14. The storage apparatus of claim 13, wherein the computing unit is further configured to:
find the candidate data block using a binary search in the index block,
check whether the data exists in the candidate data block using a bloom filter based on the filter block.

15. The storage apparatus of claim 14, wherein the computing unit is further configured to:
calculate a plurality of hash values corresponding to a key of the data using a plurality of hash functions;
match the plurality of hash values with a data structure in the filter block.

16. The storage apparatus of claim 11, wherein the computing unit is further configured to:
based on the data being found in the file, return an address of the data to the host;
based on the data not being found in the file, return a message indicating that the data is not found to the host.

17. The storage apparatus of claim 16, wherein the computing unit is further configured to:
after returning the message, receive a new search request from the host, wherein the new search request comprises a new address of a new file to be searched, and
load the new file into the computing unit in the storage apparatus based on the new address.

18. The storage apparatus of claim 17, wherein the searching for the data is ended based on the message being received by the host and the file being been traversed, or based on the address of the data being received by the host.

19. The storage apparatus of claim 12, wherein the search request is transmitted by the host by invoking a read interface in the database.

20. The storage apparatus of claim 11, wherein the computing unit comprises a dynamic random access memory (DRAM), and
wherein the computing unit is further configured to: load the file into the DRAM.

21-24. (canceled)
